(19) United States
(12) Patent Application Publication
(10) Pub. No.: US 2012/0197990 A1
(43) Pub. Date: Aug. 2, 2012

(54) PUBLISH-SUBSCRIBE MESSAGING

(75) Inventors: Li Li, Beijing (CN); Ju Wei Shi, Beijing (CN); Rui Xiong Tian, Beijing (CN); Yi Xin Zhao, Beijing (CN)

(73) Assignee: INTERNATIONAL BUSINESS MACHINES CORPORATION, Armonk, NY (US)

(21) Appl. No.: 13/283,926

(22) Filed: Oct. 28, 2011

(30) Foreign Application Priority Data
Oct. 29, 2010 (CN) 201010532070.3

(51) Int. Cl. G06F 15/16

(52) U.S. Cl. 709/204

(57) ABSTRACT

A Pub-Sub messaging method and system is disclosed. The method comprises: receiving a plurality of Pub-Sub messages; judging whether the plurality of Pub-Sub messages are similar; aggregating similar Pub-Sub messages to generate an aggregated Pub-Sub message; and transmitting the aggregated Pub-Sub message. Correspondingly, a message de-aggregating method comprises: receiving an aggregated Pub-Sub message, wherein the aggregated Pub-Sub message is generated by aggregating a plurality of similar Pub-Sub messages; de-aggregating the aggregated Pub-Sub message to recover the plurality of Pub-Sub messages; and transmitting the plurality of Pub-Sub messages.

### CROSS-REFERENCE TO RELATED APPLICATION(S)

This application claims foreign priority to P.R. China Patent application 201010532070.3 filed 29 Oct. 2010, the complete disclosure of which is expressly incorporated herein by reference in its entirety for all purposes.

### FIELD OF THE INVENTION

The present invention relates to messaging modes, and more particularly to Publish-Subscribe (Pub-Sub) messaging patterns.

### BACKGROUND OF THE INVENTION

Cloud computing is a novel Internet-based computing pattern, which provides on demand computations for individuals and enterprises through isomeric and autonomous services on the Internet. Cloud computing generally comprises services of the following levels: Infrastructure as a Service (IaaS), Platform as a Service (Paas), and Software as a Service (SaaS).

Publish-Subscribe (Pub-Sub) pattern is a messaging pattern that is widely used at present. Since it has characteristics such as asynchronization, loose coupling and many-to-many communication, it can meet requirements of the present dynamic, changeable, large-scale, distributed cloud computing environment. In the cloud computing environment, as the number of application service instances increases, the traffic of Pub-Sub rapidly increases, and Pub-Sub service flows generally take charge of carrying management control messages that have a higher priority than data messages. Since the management control messages generally have characteristics such as small packets, high transmission frequency and periodic transmission, when the system scale is enlarged and communication requirements are strong, traditional Pub-Sub services will occupy more bandwidth, thereby reducing efficiency of communication between Pub-Sub clients and remote Pub-Sub managers.

Accordingly, there is a need for improved transmission efficiency of pub-sub service flows and reduced occupied bandwidth.

### SUMMARY OF THE INVENTION

In view of the above problems, the present invention proposes a Publish-Subscribe (Pub-Sub) transmitting method and system.

According to a first aspect of the invention, provided is a Pub-Sub transmitting method, comprising: receiving a plurality of Pub-Sub messages; judging whether the plurality of Pub-Sub messages are similar; aggregating similar Pub-Sub messages to generate an aggregated Pub-Sub message; and transmitting the aggregated Pub-Sub message.

According to a second aspect of the invention, provided is a Pub-Sub transmitting method, comprising: receiving an aggregated Pub-Sub message, wherein the aggregated Pub-Sub message is generated by aggregating a plurality of similar Pub-Sub messages; de-aggregating the aggregated Pub-Sub message to recover the plurality of Pub-Sub messages; and transmitting the plurality of Pub-Sub messages.

According to a third aspect of the invention, provided is a Pub-Sub transmitting system, comprising: a message receiving module configured to receive a plurality of Pub-Sub messages; a judging module configured to judge whether the plurality of Pub-Sub messages are similar; an aggregating module configured to aggregate similar Pub-Sub messages to generate an aggregated Pub-Sub message; and an aggregated message transmitting module configured to transmit the aggregated Pub-Sub message.

According to a fourth aspect of the invention, provided is a Pub-Sub transmitting system, comprising: an aggregated message receiving module configured to receive an aggregated Pub-Sub message, wherein the aggregated Pub-Sub message is generated by aggregating a plurality of similar Pub-Sub messages; a de-aggregating module configured to de-aggregate the aggregated Pub-Sub message to recover the plurality of Pub-Sub messages; and a message transmitting module configured to transmit the plurality of Pub-Sub messages.

The Pub-Sub transmitting method and system according to the invention may aggregate and de-aggregate the Pub-Sub messages. The aggregated messages not only can decrease redundant fields in a message body, but can also reduce overheads for establishing connections between Pub-Sub clients and a Pub-Sub manager in the network, thereby reducing an amount of data transmitted over the network and the occupied bandwidth.

### BRIEF DESCRIPTION OF THE DRAWINGS

The invention per se, preferred embodiments and objects and advantages of the invention will be better understood by referring to the following exemplary embodiments described in combination with the accompanying drawings, wherein

FIG. 1 is a schematic diagram showing how a Pub-Sub messaging system operates in the prior art;

FIG. 2 shows a Pub-Sub messaging method according to an embodiment of the invention;

FIG. 3A shows a structure of an initial Pub-Sub message according to an embodiment of the invention;

FIG. 3B shows a structure of an aggregated message generated according to an embodiment of the invention;

FIG. 3C shows a structure of an aggregated message generated according to another embodiment of the invention;

FIG. 4 shows a Pub-Sub messaging method according to an embodiment of the invention;

FIG. 5 is a schematic diagram showing a Pub-Sub client architecture in a virtualized environment;

FIG. 6 shows a method of implementing Pub-Sub messaging in a virtualized environment according to an embodiment of the invention;

FIG. 7 shows an embodiment of the method of implementing Pub-Sub messaging in a virtualized environment according to an embodiment of the invention;

FIG. 8 shows a method of implementing Pub-Sub messaging in a virtualized environment according to another embodiment of the invention;

FIG. 9 shows a method of implementing Pub-Sub messaging in a virtualized environment according to a further embodiment of the invention;

FIG. 10 shows a Pub-Sub messaging system 100 according to an embodiment of the invention;

FIG. 11 shows a Pub-Sub messaging system 200 according to an embodiment of the invention; and

FIG. 12 shows a system for implementing Pub-Sub messaging in a virtualized environment according to an embodiment of the invention.

### DETAILED DESCRIPTION OF PREFERRED EMBODIMENTS

The objects and advantages of the invention will be better understood by describing the method according to the embodiments of the invention in combination with the accompanying drawings.

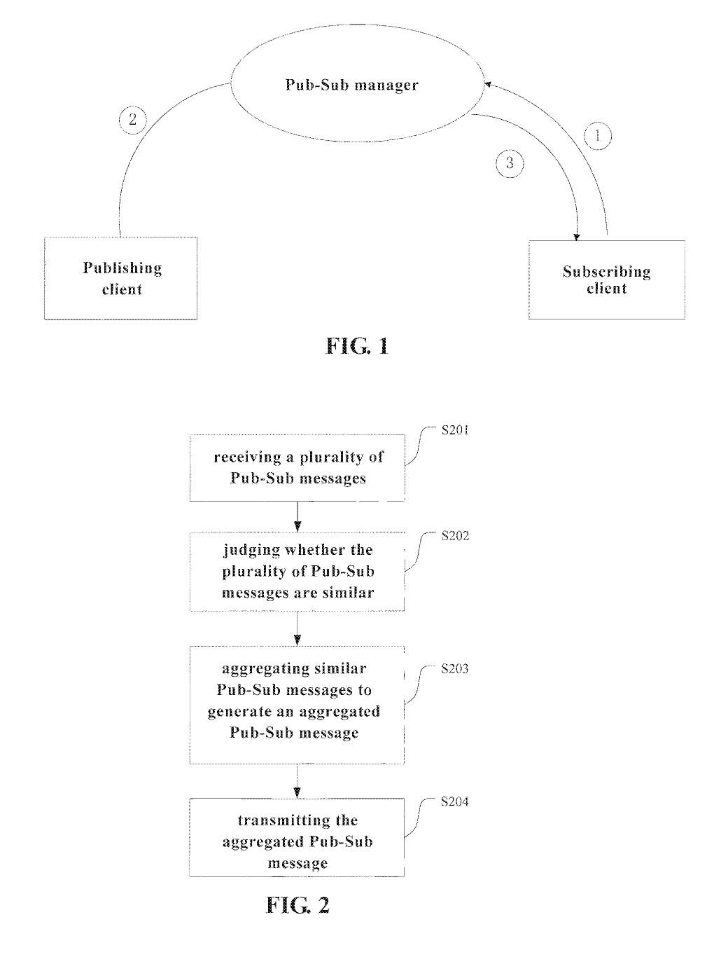

FIG. 1 is a schematic diagram showing how a Pub-Sub messaging system operates in the prior art. The Pub-Sub messaging system comprises three components, i.e., a publishing client, a subscribing client and a Pub-Sub manager. The subscribing client takes charge of subscribing to messages and receiving notifications, while the publishing client takes charge of publishing messages. The Pub-Sub messaging process comprises:
1) Subscribing: one or more subscribing clients subscribing to a specific event E with the Pub-Sub manager;
2) Publishing: publishing a corresponding message E to the Pub-Sub manager if the publishing client satisfies a condition of publishing the event E; and
3) Notifying: the subscribing client that has subscribed to the event E receiving the message E from the Pub-Sub manager.

In general, one subscription corresponds to subsequent multiple publications and notifications, until the subscription is cancelled.

A key point of the invention is that, in the Pub-Sub messaging pattern, in general, the Pub-Sub manager sends identical or similar notification messages to N subscribing clients that has subscribed to the same event, and N publishing clients generally send similar types of messages to the Pub-Sub manager. For example, for the notification messages responding to the same event, all the fields thereof are identical except for different destination addresses, and the published messages of the same type have many identical fields. In the invention, a plurality of identical or similar messages are constructed as aggregated messages at transmitting sides (publishing clients or Pub-Sub manager) and then sent out. The aggregated messages are de-aggregated at receiving side (Pub-Sub manager or subscribing clients) to be deconstructed into the plurality of messages and are transmitted to other receiving side (Pub-Sub manager or subscribing clients), thereby saving the transmission bandwidth.

FIG. 2 shows a Pub-Sub messaging method according to an embodiment of the invention. The method comprises: a step S201 of receiving a plurality of Pub-Sub messages; a step S202 of judging where the plurality of Pub-Sub messages are similar; a step S203 of aggregating similar Pub-Sub messages to generate an aggregated Pub-Sub message; and a step S204 of transmitting the aggregated Pub-Sub message.

At step S201 of receiving the plurality of Pub-Sub messages, the messages are transmitted by network protocols such as TCP/IP. According to an embodiment of the invention, the plurality of Pub-Sub messages are messages published from the Pub-Sub clients, and the published messages transmitted by the Pub-Sub clients to the Pub-Sub manager are received at the side of the Pub-Sub clients. According to another embodiment of the invention, the plurality of Pub-Sub messages are notification messages received from the Pub-Sub manager, that is, the notification messages that were transmitted by the Pub-Sub manager to the Pub-Sub clients are intercepted.

At step S202 of judging whether the plurality of Pub-Sub messages are similar, specifically, the judging whether the messages are similar can be performed based on at least one of: judging whether the Pub-Sub messages are similar based on names of the messages, because generally the Pub-Sub messages having the same name are similar to each other; judging whether the Pub-Sub messages are similar based on length of the messages; judging whether the Pub-Sub messages are similar based on response event identifiers of the messages; determining whether the plurality of Pub-Sub messages are similar by comparing contents of the fields of the plurality of Pub-Sub messages, i.e. comparing character strings in the fields of the compared Pub-Sub messages.

The step S203 of aggregating similar Pub-Sub messages to generate an aggregated Pub-Sub message, specifically comprises: extracting fields with identical contents and fields with different contents contained in the Pub-Sub messages; removing redundancies of the fields with identical contents and combining the fields with different contents; generating an aggregation control field identifying an aggregation mapping relation of the Pub-Sub messages; and constructing an aggregated Pub-Sub message by using the fields with identical contents from which redundancies have been removed, the fields with different contents, and the aggregation control field, wherein the aggregation control field identifies positions of the fields with identical contents and the fields with different contents and to which Pub-Sub messages the fields with different contents respectively correspond.

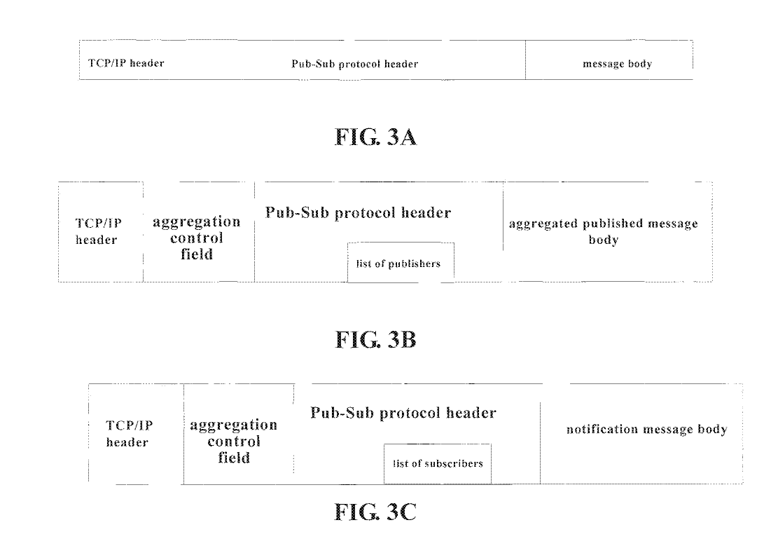

According to an embodiment of the invention, following the above-described method, if the plurality of published messages A, B and C published by the Pub-Sub clients are determined to be similar, then fields with identical contents and fields with different contents contained in the plurality of published messages A, B and C are extracted and the fields with identical contents and the fields with different contents are re-constructed to generate an aggregated message. FIG. 3A shows a structure of an initial Pub-Sub message according to an embodiment of the invention. By taking TCP/IP network transmission as an example, the structure of a Pub-Sub message includes a TCP/IP header, a Pub-Sub protocol header and a message body. FIG. 3B shows a structure of an aggregated message generated according to an embodiment of the invention, where in the structure of the Pub-Sub message, the message bodies of the published messages A, B and C are aggregated, redundancies of the fields with identical contents are removed but only one of the fields with identical contents is reserved, and a field representing a list of addresses of the publishers is added to the Pub-Sub protocol header while reserving the contents of the fields with identical contents in the Pub-Sub protocol header. Fields with different contents are combined to generate fields representing aggregated published message bodies, and an aggregation control field for identifying an aggregation mapping relation of the plurality of Pub-Sub messages is generated between the TCP/IP header and the Pub-Sub protocol header. According to an embodiment of the invention, the fields representing the aggregated published message bodies can be compressed to generate compressed fields representing the published message bodies and compression parameters can be added to the aggregation control field.

According to another embodiment of the invention, following the above-described method, the plurality of notification messages A, B and C published by the Pub-Sub manager are determined to be identical. FIG. 3C shows a structure of an aggregated message generated according to another embodiment of the invention, where in the structure of the Pub-Sub message, only one copy of fields representing the notification message bodies with identical contents are reversed, a field representing a list of addresses of the subscribers is added to the Pub-Sub protocol header while reserving the contents of the fields with identical contents in the Pub-Sub protocol header, and an aggregation control field for identifying an aggregation mapping relation of the plurality of Pub-Sub messages is generated between the TCP/IP header and the Pub-Sub protocol header.

At step S204, the aggregated Pub-Sub message is transmitted. The plurality of Pub-Sub messages are placed with an aggregated Pub-Sub message, thereby reducing an amount of data transmitted over the network and the occupied bandwidth.

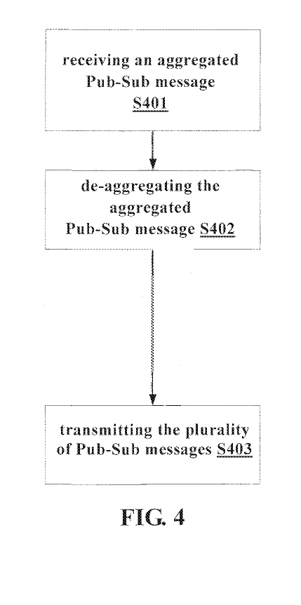

FIG. 4 shows a Pub-Sub messaging method according to an embodiment of the invention, corresponding to the Pub-Sub messaging method shown in the embodiment of FIG. 2. The method comprises: a step S401 of receiving an aggregated Pub-Sub message, wherein the aggregated Pub-Sub message is generated by aggregating a plurality of similar Pub-Sub messages; a step S402 of de-aggregating the aggregated Pub-Sub message to recover the plurality of Pub-Sub messages; and a step S403 of transmitting the plurality of Pub-Sub messages.

At step S401 of receiving an aggregated Pub-Sub message, the aggregated Pub-Sub message is generated by aggregating the plurality of similar Pub-Sub messages, wherein the method of aggregating the Pub-Sub messages may be implemented with reference to the embodiments of FIGS. 3b-3c.

At step S402 of de-aggregating the aggregated Pub-Sub message to recover the plurality of Pub-Sub messages, de-aggregating is an inverse of aggregating, i.e. deconstructing the aggregated Pub-Sub messages. According to an embodiment of the invention, continuing the example where the Pub-Sub clients publish the plurality of published similar messages A, B, C, after the aggregated published messages shown in FIG. 3b is received at side of the Pub-Sub manager, the aggregation control field is extracted from the aggregated Pub-Sub messages, wherein the aggregation control field is used for identifying the aggregation mapping relation of the plurality of Pub-Sub messages. The aggregated Pub-Sub message is de-aggregated based on the aggregation control field. The plurality of Pub-Sub messages are recovered, that is, the aggregated published message is recovered to be the initial plurality of published messages A, B and C in the format of the initial Pub-Sub messages. Then at step S403, the plurality of published Pub-Sub messages A, B and C are transmitted to the Pub-Sub manager. According to another embodiment of the invention, continuing the example where the Pub-Sub manager publishes the plurality of identical notification messages A, B and C, the aggregated notification message as shown in FIG. 3C is received at side of the Pub-Sub clients. The aggregation control field for identifying the aggregation mapping relation of the plurality of Pub-Sub messages is extracted from the aggregated Pub-Sub message. The aggregated Pub-Sub message is de-aggregated based on the aggregation control field. The plurality of Pub-Sub messages are recovered. Then, the aggregated notification messages are recovered to be the initial plurality of notification messages in the format of the initial notification messages. The plurality of notification messages are transmitted to the Pub-Sub clients at step S403.

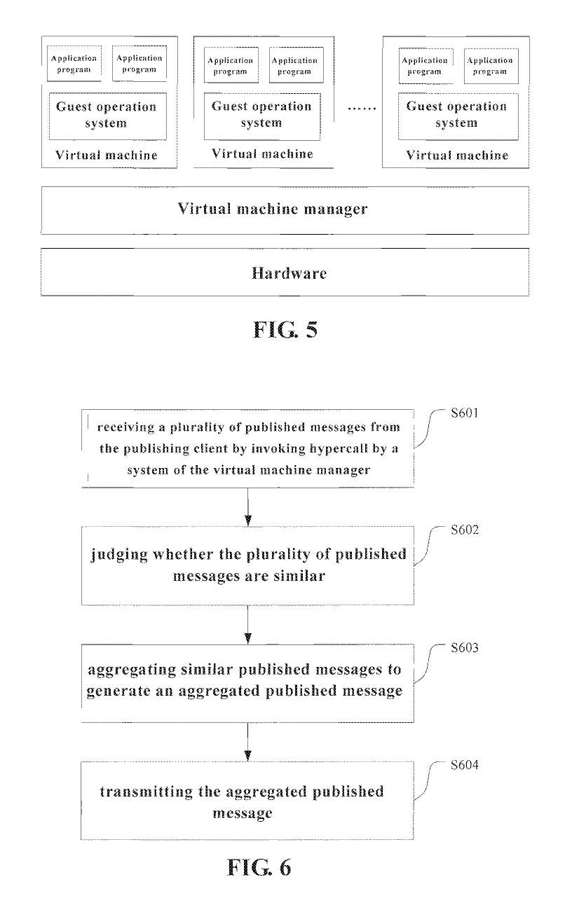

According to an embodiment of the invention, Pub-Sub messaging is implemented in a virtualized environment. FIG. 5 is a schematic diagram showing a Pub-Sub client architecture in a virtualized environment. The virtualized environment comprises a physical machine, a virtual machine hypervisor and a plurality of virtual machines, wherein the virtual machines are strictly isolated software containers which comprise a plurality of guest operation systems (OS) and a plurality of application programs running on each guest operation system. A plurality of virtual machines that can have different operation systems run on the same physical machine independently and in parallel with each other, such that resource sharing on a single physical machine can be realized between the plurality of virtual machines. Virtual machine hypervisor is a software layer that provides virtualization of bottom-layer machines. It runs over physical hardware, and manages and supports the virtual machines on the bottom layer to allocate hardware resources to the virtual machines dynamically and transparently. The embodiments of the invention may run in the virtual machine operating environments such as Xen, VMWare, LPAR, or the like, or may be any type of virtual machines independent of the platform.

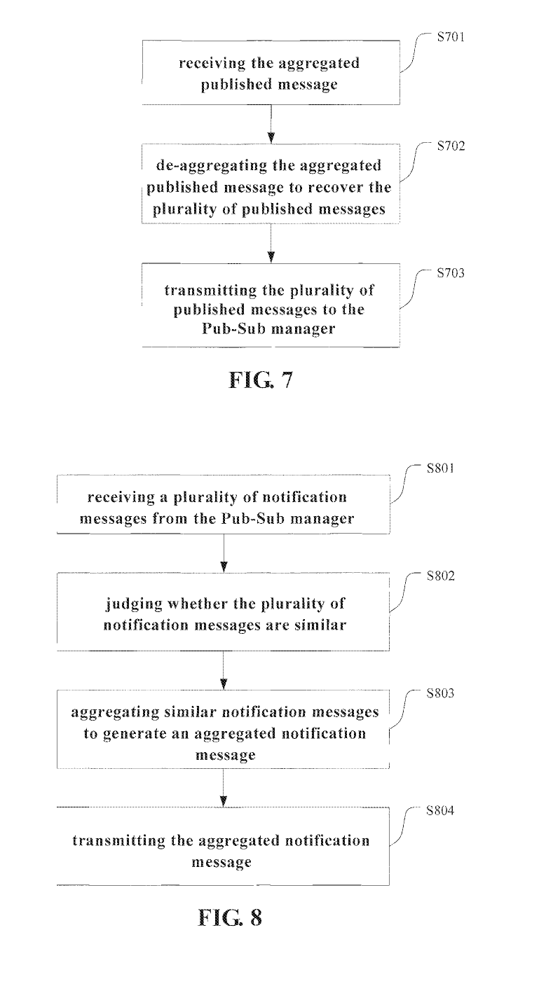

Specifically, FIG. 6 shows a method of implementing Pub-Sub messaging in the virtualized environment according to an embodiment of the invention, comprising: a step S601 of receiving a plurality of published messages from the publishing client by invoking hypercall by a system of a virtual machine manager, wherein the publishing client is an application program deployed in virtual machine, and although messaging can be performed through TCP/IP protocol, a time delay of messaging by invoking hypercall by the system is shorter and overheads for network traffics can be saved; a step S602 of judging whether the plurality of published messages are similar; a step S603 of aggregating similar published messages to generate an aggregated message; and a step S604 of transmitting the aggregated published message. The steps of S602, S603 and S604 are implemented in the virtual machine manager. Correspondingly, FIG. 7 shows a method of implementing Pub-Sub messaging in a virtualized environment according to an embodiment of the invention, comprising: a step S701 of receiving the aggregated published message; a step S702 of de-aggregating the aggregated published message to recover the plurality of published messages; and a step of S703 of transmitting the plurality of published messages to the Pub-Sub manager.

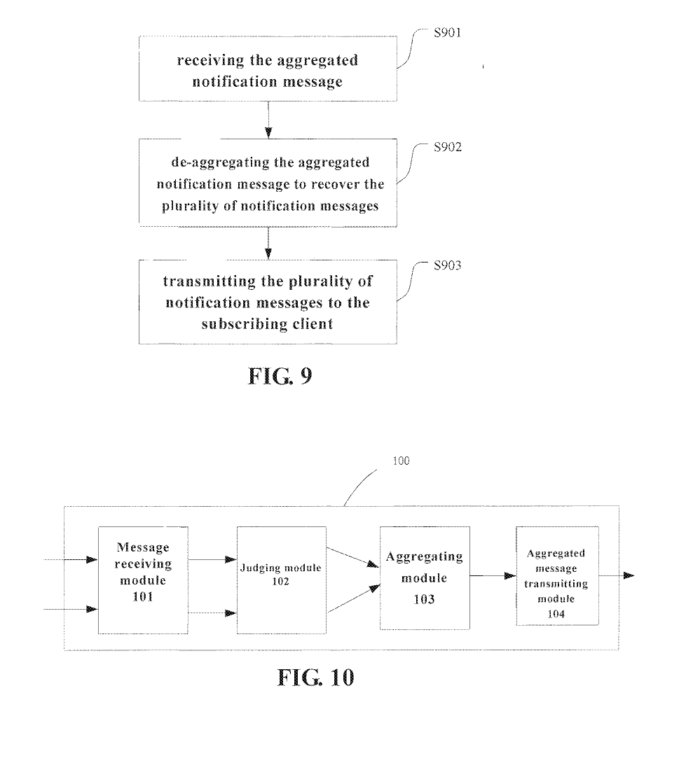

FIG. 8 shows a method of implementing Pub-Sub messaging in a virtualized environment according to another embodiment of the invention, comprising: a step S801 of receiving a plurality of notification messages from the Pub-Sub manager; a step S802 of judging whether the plurality of notification messages are similar; a step S803 of aggregating similar notification messages to generate an aggregated notification message; a step S804 of transmitting the aggregated notification message. Correspondingly, FIG. 9 shows a method of implementing Pub-Sub messaging in a virtualized environment according to a further embodiment of the invention, comprising: a step S901 of receiving an aggregated notification message; a step S902 of de-aggregating the aggregated notification message to recover the plurality of notification messages; and a step S903 of transmitting the plurality of notification messages to the subscribing client by invoking hypercall by the system of the virtual machine manager.

Based on a same inventive concept, the present invention proposes a Pub-Sub messaging system according to an embodiment of the invention. FIG. 10 shows a Pub-Sub messaging system 100 according to an embodiment of the invention, comprising: a message receiving module 101 configured to receive a plurality of Pub-Sub messages; a judging module 102 configured to judge whether the plurality of Pub-Sub messages are similar; an aggregating module 103 configured to aggregate similar Pub-Sub messages to generate an aggregated Pub-Sub message; and an aggregated message transmitting module 104 configured to transmit the aggregated Pub-Sub message. According to an embodiment of the invention, the plurality of Pub-Sub messages are a plurality of published messages from the Pub-Sub clients. Further according to an embodiment of the invention in the virtualized environment, the message receiving module receives the plurality of published messages by invoking hypercall by the system of the virtual machine manager. According to another embodiment of the invention, the plurality of Pub-Sub messages are notification messages from the Pub-Sub manager.

The aggregating module 103 further comprises: an extracting module configured to extract fields with identical contents and fields with different contents contained in the plurality of Pub-Sub messages; a combining module configured to remove redundancies of the fields with identical contents and combine the fields with different contents; a control field generating module configured to generate an aggregation control field identifying an aggregation mapping relation of the plurality of Pub-Sub messages; and an aggregation message constructing module configured to construct the aggregated Pub-Sub message by using the fields with identical contents from which redundancies have been removed, the fields with different contents, and the aggregation control field.

The judging module 102 judges whether the plurality of Pub-Sub messages are similar based on at least one of the following : names of the plurality of Pub-Sub messages; response event identifiers of the plurality of Pub-Sub messages; length of the plurality of Pub-Sub messages; and comparison of contents of the fields of the plurality of Pub-Sub messages.

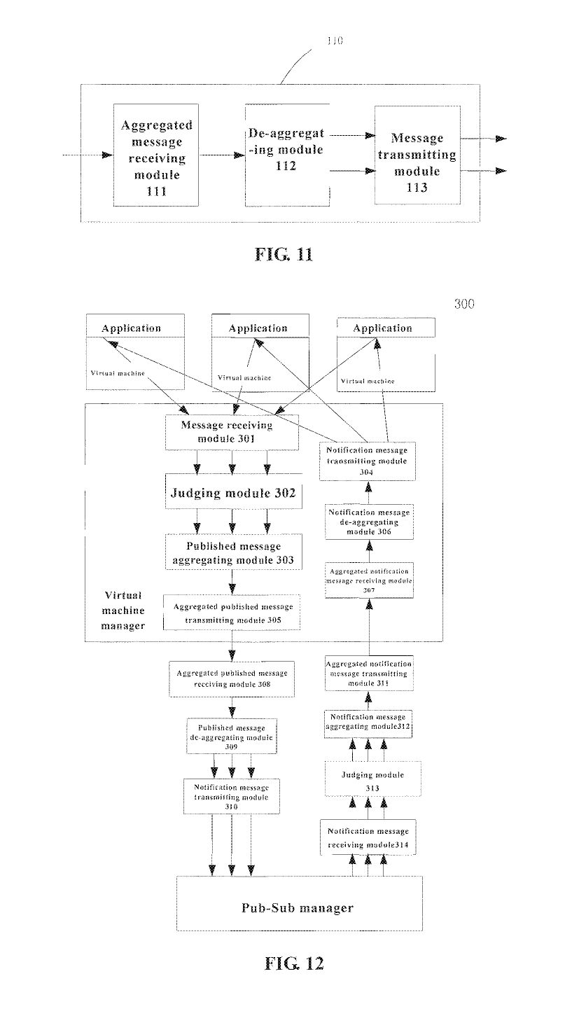

Corresponding to the system of FIG. 10, FIG. 11 shows a Pub-Sub messaging system 110 according to an embodiment of the invention, comprising: an aggregated message receiving module 111 configured to receive the aggregated Pub-Sub message, wherein the aggregated Pub-Sub message are generated by aggregating a plurality of similar Pub-Sub messages; a de-aggregating module 112 configured to de-aggregate the aggregated Pub-Sub message to recover the plurality of Pub-Sub messages; and a message transmitting module 113 configured to transmit the plurality of Pub-Sub messages.

The de-aggregating module 112 is further configured to extract an aggregation control field from the aggregated Pub-Sub message, wherein the aggregation control field is used for identifying an aggregation mapping relation of the plurality of Pub-Sub messages; and de-aggregate the aggregated Pub-Sub message based on the aggregation control field to recover the plurality of Pub-Sub messages. According to an embodiment of the invention, the plurality of similar Pub-Sub messages are a plurality of published messages from the Pub-Sub clients. According to another embodiment of the invention, the plurality of similar Pub-Sub messages are a plurality of notification messages from the Pub-Sub manager. According to an embodiment of the invention in the virtualized environment, the message transmitting module transmits the plurality of notification messages by invoking hypercall by the system of the virtual machine manager.

FIG. 12 shows a system 300 for implementing Pub-Sub messaging in a virtualized environment according to an embodiment of the invention. According to an embodiment of the invention, the system 300 implements the transmission of the published messages from the Pub-Sub clients to the Pub-Sub manager, and comprises: an information receiving module 301 configured to receive a plurality of published messages from the publishing client by invoking hypercall by the system of the virtual machine manager, wherein the publishing client is an application program deployed in virtual machine; a judging module 302 configured to judge whether the plurality of published messages are similar; a published message aggregating module 303 configured to aggregate similar published messages to generate an aggregated published message; an aggregated published message transmitting module 305 configured to transmit the aggregated published message; an aggregated published message receiving module 308 configured to receive the aggregated published message; a published message de-aggregating module 309 configured to de-aggregate the aggregated published message to recover the plurality of published messages; and a notification message transmitting module 310 configured to transmit the plurality of published messages to the Pub-Sub manager.

According to an embodiment of the invention, the system 300 implements the transmission of the notification messages from the Pub-Sub manager to the Pub-Sub clients, and comprises: a notification message receiving module 314 configured to receive a plurality of notification messages from the Pub-Sub manager; a judging module 313 configured to judge whether the plurality of notification messages are similar; a notification message aggregating module 312 configured to aggregate similar notification messages to generate an aggregated notification message; an aggregated notification message transmitting module 311 configured to transmit the aggregated notification message; an aggregated notification message receiving module 307 configured to receive the aggregated notification message; a notification message de-aggregating module 306 configured to de-aggregate the aggregated notification message to recover the plurality of notification messages; and a notification message transmitting module 304 configured to transmit the plurality of notification messages to the subscribing client by invoking hypercall by the system of the virtual machine manager.

It should be appreciated that, at least some aspects of the invention can be alternatively realized by a program product. The program that defines functions of the invention can be transmitted to a data storage system or computer system through various signal carrying medium. The signal carrying medium may be, for example, but not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium supporting for example the Internet or Intranet, or a magnetic storage device. It should be appreciated that, when the signal carrying medium is carried with or is encoded with computer readable instructions for managing functions of the invention, they represent alternative embodiments of the invention. The invention can be implemented by means of hardware, software, firmware or a combination thereof. The invention can be implemented in a single computer system in a concentrated manner, or a distributed manner in which different components are distributed on several interconnected computer systems. Any computer system or other apparatuses adapted to execute the method of the invention are appropriate. Preferably, the invention is implemented by means of a combination of computer software and universal computer hardware in which, when the computer program is loaded or executed, the computer system is controlled to perform the method of the invention or constitute the system of the invention.

Thus, having reviewed the disclosure herein, the skilled artisan will appreciate that aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Distinct software modules for carrying aspects of embodiments of the invention can be, in at least some cases, embodied on a computer readable storage medium. The distinct software modules may include, for example, any one, some, or all of the modules and/or sub-modules in FIGS. 5, 10, 11, and 12.

The means mentioned herein can include (i) hardware module(s), (ii) software module(s) executing on one or more hardware processors, or (iii) a combination of hardware and software modules; any of (i)-(iii) implement the specific techniques set forth herein, and the software modules are stored in a computer readable medium (or multiple such media).

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A Publish-Subscribe (Pub-Sub) messaging method, comprising:
receiving a plurality of Pub-Sub messages;
judging whether the plurality of Pub-Sub messages are similar;
aggregating similar Pub-Sub messages to generate an aggregated Pub-Sub message; and
transmitting the aggregated Pub-Sub message.

2. The method according to claim 1, wherein aggregating similar Pub-Sub messages to generate the aggregated Pub-Sub message further comprises:
extracting fields with identical contents and fields with different contents contained in the plurality of Pub-Sub messages;
removing redundancies of the fields with identical contents and combining the fields with different contents;
generating an aggregation control field for identifying an aggregation mapping relation of the plurality of Pub-Sub messages; and
constructing the aggregated Pub-Sub message by using the fields with identical contents from which redundancies have been removed, the fields with different contents, and the aggregation control field.

3. The method according to claim 2, wherein whether the plurality of Pub-Sub messages judged to be similar are judged based on at least one of the following:
names of the plurality of Pub-Sub messages, response event identifiers of the plurality of Pub-Sub messages, length of the plurality of Pub-Sub messages, and comparison of contents of the fields of the plurality of Pub-Sub messages.

4. The method according to claim 1, wherein the plurality of Pub-Sub messages are a plurality of published messages from Pub-Sub clients.

5. The method according to claim 4, wherein the plurality of published messages are received by invoking hypercall by a system of a virtual machine manager.

6. The method according to claim 1, wherein the plurality of Pub-Sub messages are notification messages from a Pub-Sub manager.

7. A Publish-Subscribe (Pub-Sub) messaging method, comprising:
receiving an aggregated Pub-Sub message, wherein the aggregated Pub-Sub message is generated by aggregating a plurality of similar Pub-Sub messages;
de-aggregating the aggregated Pub-Sub message to recover the plurality of Pub-Sub messages; and
transmitting the plurality of Pub-Sub messages.

8. The method according to claim 7, wherein de-aggregating the aggregated Pub-Sub message to recover the plurality of Pub-Sub messages further comprises:
extracting an aggregation control field from the aggregated Pub-Sub message, wherein the aggregation control field is used for identifying an aggregation mapping relation of the plurality of Pub-Sub messages; and
de-aggregating the aggregated Pub-Sub message based on the aggregation control field to recover the plurality of Pub-Sub messages.

9. The method according to claim 7, wherein the plurality of similar Pub-Sub messages are a plurality of published messages from Pub-Sub clients.

10. The method according to claim 7, wherein the plurality of similar Pub-Sub messages are a plurality of notification messages from a Pub-Sub manager.

11. The method according to claim 10, wherein the plurality of notification messages are transmitted by invoking hypercall by a system of a virtual machine manager.

12. A Publish-Subscribe (Pub-Sub) messaging system, comprising:
a message receiving module configured to receive a plurality of Pub-Sub messages;
a judging module configured to judge whether the plurality of Pub-Sub messages are similar;
an aggregating module configured to aggregate similar Pub-Sub messages to generate an aggregated Pub-Sub message; and
an aggregated message transmitting module configured to transmit the aggregated Pub-Sub message.

13. The system according to claim 12, wherein the aggregating module further comprises:
an extracting module configured to extract fields with identical contents and fields with different contents contained in the plurality of Pub-Sub messages;
a combining module configured to remove redundancies of the fields with identical contents and combine the fields with different contents;
a control field generating module configured to generate an aggregation control field for identifying an aggregation mapping relation of the plurality of Pub-Sub messages; and
an aggregated message constructing module configured to construct the aggregated Pub-Sub message by using the fields with identical contents from which redundancies have been removed, the fields with different contents, and the aggregation control field.

14. The system according to claim 13, wherein the judging module judges whether the plurality of Pub-Sub messages are similar based on at least one of the following:
names of the plurality of Pub-Sub messages, response event identifiers of the plurality of Pub-Sub messages, length of the plurality of Pub-Sub messages, and comparison of contents of the fields of the plurality of Pub-Sub messages.

15. The system according to claim 12, wherein the plurality of Pub-Sub messages are a plurality of published messages from Pub-Sub clients.

16. The system according to claim 14, wherein the message receiving module receives the plurality of published messages by invoking hypercall by a system of a virtual machine manager.

17. The system according to claim 12, wherein the plurality of Pub-Sub messages are notification messages from a Pub-Sub manager.

18. A Publish-Subscribe (Pub-Sub) messaging system, comprising:
an aggregated message receiving module configured to receive an aggregated Pub-Sub message, wherein the aggregated Pub-Sub message is generated by aggregating a plurality of similar Pub-Sub messages;
a de-aggregating module configured to de-aggregate the aggregated Pub-Sub message to recover the plurality of Pub-Sub messages; and
a message transmitting module configured to transmit the plurality of Pub-Sub messages.

19. The system according to claim 18, wherein the de-aggregating module is further configured to:
extract an aggregation control field from the aggregated Pub-Sub message, wherein the aggregation control field is used for identifying an aggregation mapping relation of the plurality of Pub-Sub messages; and
de-aggregate the aggregated Pub-Sub message based on the aggregation control field to recover the plurality of Pub-Sub messages.

20. The system according to claim 18, wherein the plurality of similar Pub-Sub messages are a plurality of published messages from Pub-Sub clients.

21. The system according to claim 18, wherein the plurality of similar Pub-Sub messages are a plurality of notification messages from a Pub-Sub manager.

22. The system according to claim 21, wherein the message transmitting module transmits the plurality of notification messages by invoking hypercall by a system of a virtual machine manager.
